(19) United States
(12) Patent Application Publication
(10) Pub. No.: US 2008/0160320 A1
(43) Pub. Date: Jul. 3, 2008

(54) Radically Curable Coating Compounds

(75) Inventors: Erich Beck, Ladenburg (DE); Reinhold Schwalm, Wachenheim (DE); Katia Studer, Mulhouse (FR); Phuong Nguyen Tri, Paris Cedex (FR); Christian Decker, Rixheim (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/816,741

(22) PCT Filed: Mar. 3, 2006
(86) PCT No.: PCT/EP06/60417

§ 371 Date: Aug. 21, 2007

(30) Foreign Application Priority Data
Mar. 3, 2005 (DE) 102005010327.8

(51) Int. Cl. B32B 27/40; C08F 2/46

(52) U.S. Cl. 428/423.4; 522/13; 428/425.1; 428/425.8; 428/425.6

(57) ABSTRACT

The present invention relates to free-radically curable coating compositions, to methods of curing such coating compositions, and to their use.

The present invention relates to free-radically curable coating compositions, to methods of curing such coating compositions, and to their use.

Free-radically curable coating compositions which are initiated using amine-peroxide initiator systems are widespread in the literature in the form of what are known as curing agent/accelerant systems or redox initiator systems.

A disadvantage of such accelerants, of which dimethylaniline or dimethyl-p-toluidine are examples for dibenzoyl peroxide, for example, or of which cobalt salts are examples for ketone peroxides, is that the reactivity of the peroxides used is increased in some cases so drastically that paints that are to be cured with such systems have an extremely short pot life, which limits their usefulness.

Moreover, after weathering, the amines employed often exhibit a yellowing which is undesirable in paints with light-colored pigmentation or in clear coating materials.

Numerous investigations focus on the reactivity of redox initiator systems:

G. David, C. Loubat, B. Boutevin, J. J. Robin, and C. Moustrou describe in Eur. Polym. J. 39 (2003), 77-83 the polymerization of ethyl acrylate with a redox initiator system comprising dibenzoyl peroxide and dimethylaniline under a nitrogen atmosphere.

B. Vazquez, C. Elvira, J. San Roman, B. Levenfeld, Polymer 38 (1997), 4365-4372 describes in a similar way the polymerization of methyl methacrylate with a redox initiator system comprising dibenzoyl peroxide and dimethyltoluidine under a nitrogen atmosphere.

Also known is the combination of a free-radical, thermally induced cure with other cure mechanisms (dual cure):

H. Xie, J. Guo, Eur. Polym. J. 38 (2002), 2271-2277 polymerize methacrylates with a dibenzoyl peroxide and dimethylaniline and at the same time, by reaction of an isocyanate-containing component with polymeric diols, construct an interpenetrating network.

K. Dean, W. D. Cook, M. D. Zipper, P. Burchill, Polymer 42 (2001), 1345-1359 describes interactions of primary amines as curing agents for epoxy resins on the free-radical cure of a styrene/bisphenol A diglycidyl dimethacrylate system with different peroxy compounds, such as cumyl hydroperoxide, dibenzoyl peroxide, and butanone peroxide.

X. Feng, K. Qiu, W. Cao, Handbook of Engineering Polymeric Materials (1997), 227-242 describe redox initiator systems comprising N-hydroxyalkylated aromatic amines and dibenzoyl peroxide.

Another passage in the same document addresses the activation of the benzophenone photoinitiator with primary or secondary amines.

A combination of these specific mechanisms, however, is not disclosed.

It was an object of the present invention to provide coating compositions which, through the use of two independent initiator systems, can be cured free-radically and at the same time enjoy a good pot life and do not lead to yellowing of the finished coating.

This object has been achieved by means of free-radically curable coating compositions comprising

a) at least one compound (I) having at least one peroxy group,

b) at least one aromatic amine of the formula (II)

Ar-NR¹R²,

in which

Ar is an optionally substituted aromatic ring system having 6 to 20 carbon atoms and

R¹ and R² each independently of one another are optionally substituted alkyl radicals, with the proviso that at least one of the two radicals R¹ and R² has at least 2 carbon atoms,

c) at least one compound having at least one ethylenically α, β-unsaturated carbonyl compound,

d) at least one photoinitiator, and

e) if appropriate, at least one pigment.

It is an advantage of the present coating compositions that they can be initiated both thermally and photochemically and that the reactivity of the thermal free-radical initiator system is fine-tuned such that the system exhibits on the one hand a sufficiently high reactivity and on the other an effective storage stability (pot life). The amines used, moreover, exhibit reduced propensity to yellowing.

The coating compositions of the invention comprise the following components:

a) at least one compound (I) having at least one peroxy group.

Compounds (I) are compounds which comprise at least one peroxy group (—O—O—).

They may be
a1) peroxidic salts,
a2) hydrogen peroxide,
a3) hydroperoxides, i.e., compounds comprising at least one hydroperoxide group (—O—O—H), or
a4) peroxides, i.e., compounds with organic substituents either side of the peroxy group (—O—O—).

Examples are those listed in Polymer Handbook ed. 1999, Wiley & Sons, New York.

Examples of compounds al) are peroxodisulfates, e.g., potassium, sodium or ammonium peroxodisulfate, peroxides, e.g., sodium peroxide or potassium peroxide, perborates, e.g., ammonium, sodium or potassium perborate, monopersulfates, e.g., ammonium, sodium or potassium hydrogen monopersulfate, and salts of the peroxycarboxylic acids listed under a4), e.g., ammonium, sodium, potassium or magnesium monoperoxyphthalate.

a2) is hydrogen peroxide, in the form for example of an aqueous solution in a concentration of 10% to 50% by weight.

Examples of compounds a3) are tert-butyl hydroperoxide, tert-amyl hydroperoxide, cumyl hydroperoxide, peracetic acid, perbenzoic acid, monoperphthalic acid or meta-chloroperbenzoic acid.

Examples of compounds a4) are ketone peroxides, dialkyl peroxides, diacyl peroxides or mixed acyl alkyl peroxides.

Examples of diacyl peroxides are dibenzoyl peroxide and diacetyl peroxide. Examples of dialkyl peroxides are di-tert-butyl peroxide, dicumyl peroxide, bis(α, α-dimethylbenzyl) peroxide, and diethyl peroxide.

An example of mixed acyl alkyl peroxides is tert-butyl perbenzoate. Ketone peroxides are, for example, acetone peroxide, butanone peroxide, and 1,1′-peroxybiscyclohexanol.

Others are, for example, 1,2,4-trioxolane or 9,10-dihydro-9,10-epidioxidoanthracene.

Preferred compounds a) are the compounds a1), a3) and a4), more preferably compounds a3) and a4), and very preferably the compounds a4). Among these, preference is given to diacyl peroxides, dialkyl peroxides, and ketone peroxides, particular preference to diacyl peroxides and dialkyl peroxides, and very particular preference to diacyl peroxides.

Dibenzoyl peroxide in particular is a preferred compound a).

The compounds a) are generally solid and can be incorporated into the coating composition either in solid form or in solution or suspension in a suitable solvent. It is preferred to use a solution or suspension in one of the compounds c) of the coating composition of the invention, more preferably a solution.

b) At least one aromatic amine of the formula (II)

Ar—NR¹R²,

in which

Ar is an optionally substituted aromatic ring system having 6 to 20 carbon atoms and

R¹ and R² each independently of one another are optionally substituted alkyl radicals, with the proviso that at least one of the two radicals R¹ and R² has at least 2 carbon atoms.

Examples of Ar are phenyl and α- or β-naphthyl radicals that are optionally substituted by one or more C₁ to C₁₂ alkyl, C₁ to C₁₂ alkyloxy, C₆ to C₁₂ aryl, C₆ to C₁₂ aryloxy, C₅ to C₁₂ cycloalkyl, C₅ to C₁₂ cycloalkyloxy or halogen substituents.

The substituents may be straight-chain or branched and may in turn be substituted.

C₁ to C₁₂ alkyl therein is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonyl-propyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyl-oxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-odecylthioethyl, 2-phenylthioethyl, 2,2,2-trifluoroethyl, 2-hydroxyethyl, 2-hydroxypropyl, 3-hydroxy- propyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methyl-aminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethyl-aminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl;

C₆-C₁₂ aryl therein is for example phenyl, tolyl, xylyl, α-naphthyl, β-naphthyl, 4-biphenylyl, chlorophenyl, dichlorophenyl, trichlorophenyl, difluorophenyl, methyl-phenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl;

substituted C₅-C₁₂ cycloalkyl therein is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, and a saturated or unsaturated bicyclic system such as norbornyl or norbornenyl, for example;

examples of Ar are phenyl, o-, m- or p-tolyl, 2,4-dimethylphenyl, 2,4,6-trimethylphenyl, 2-, 4- or 6-ethylphenyl, 2,4-diethylphenyl, 2,4,6-triethylphenyl, 2-, 4- or 6-chlorophenyl, 2,4-dichlorophenyl, 2,4,6-trichlorophenyl, 2-, 4- or 6-methoxyphenyl, 2,4-dimethoxy-phenyl, 2,4,6-trimethoxyphenyl, and α- or β-naphthyl.

Preferred radicals Ar are phenyl, p-tolyl, 4-chlorophenyl, 4-methoxyphenyl, and naphthyl, particular preference being given to phenyl and p-tolyl and very particular preference to phenyl.

Examples of R¹ and, independently thereof, of R² are C₁ to C₁₂ alkyl radicals optionally substituted by C₁ to C₁₂ alkyloxy, C₆ to C₁₂ aryl, C₆ to C₁₂ aryloxy, C₅ to C₁₂ cycloalkyl, C₅ to C₁₂ cycloalkyloxy, hydroxyl or halogen substituents, alkyl, aryl, and cycloalkyl taking on the above definitions.

Examples of R¹ and, independently thereof, of R² are methyl, ethyl, n-propyl, isopropyl, n-butyl, isobutyl, sec-butyl, tert-butyl, n-hexyl, 2-hydroxyethyl, 2-hydroxypropyl, 1-methyl-2-hydroxyethyl, 2-methyl-2-hydroxypropyl, 2-cyanoethyl, 2-methoxycarbonylethyl, 2-ethoxycarbonylethyl, 2-n-butoxycarbonylethyl or benzyl.

In accordance with the invention at least one of the two radicals R¹ and R² has at least two carbon atoms.

Preferably both radicals R¹ and R² have at least two carbon atoms.

Particularly preferred radicals R¹ and R² are hydroxy-substituted C₂-C₁₂ alkyl radicals.

Especially preferred radicals R¹ and R², independently of one another, are ethyl, isopropyl, 2-hydroxyethyl, 2-hydroxypropyl, and benzyl, particular preference being given to 2-hydroxyethyl and 2-hydroxypropyl, and especially 2-hydroxyethyl.

Preferably the radicals R¹ and R² are the same.

In one preferred embodiment at least one of the two radicals R¹ and R² has at least one hydrogen atom on the carbon atom adjacent to the nitrogen atom, i.e., the α carbon atom, and more preferably both radicals R¹ and R² have at least one hydrogen atom on the α carbon atom.

Preferred compounds b) are N,N-diethylaniline, N,N-di-n-butylaniline, N,N-diisopropyl-aniline, N-methyl-N-(2-hydroxyethyl)aniline, N-methyl-N-(2-hydroxyethyl)-p-tolidine, N, N-diethyl-o-tolidine, N ,N-di-n-butyl-o-tolidine, N,N-diethyl-p-tolidine, N, N-di-n-butyl-p-tolidine, N,N-di(2-hydroxyethyl)aniline, N,N-di(2-hydroxyethyl)-o-tolidine, N,N-di(2-hydroxyethyl)-p-tolidine, N,N-di(2-hydroxypropyl)aniline, N,N-di(2-hydroxypropyl)-p-tolidine, and N,N-di(2-hydroxypropyl)-o-tolidine. Particular preference is given to N,N-di(2-hydroxyethyl)aniline, N,N-di(2-hydroxyethyl)-p-tolidine, N, N-di(2-hydroxypropyl)-aniline, and N,N-di(2-hydroxypropyl)-p-tolidine. Very particular preference is given to N,N-di(2-hydroxyethyl)aniline and N,N-di(2-hydroxyethyl)-p-tolidine, and particular preference to N, N-di(2-hydroxyethyl)aniline.

Examples of known accelerants for peroxidic initiators include dimethylaniline and dimethyl-p-toluidine. By virtue of the fact that, in accordance with the invention, at least one of the two radicals R¹ and R², preferably both, has/have at least two carbon atoms, the reactivity of the amine-peroxide initiator system of the invention is fine-tuned with precision, so that the coating compositions comprising such a system have on the one hand a sufficient reactivity and on the other a sufficient pot life.

Since the reactivity plays a decisive part in accordance with the invention, preference is given to those amines, in particular of the formula (II) in a mixture with peroxy compounds a), which in a reference system have a reactivity similar to that of the redox initiator system N,N-di(2-hydroxyethyl)aniline/dibenzoyl peroxide.

To this end a 0.5% by weight preparation of the respective amine is mixed with 1.5% by weight of the respective peroxy compound in methyl methacrylate (freshly distilled) at 25° C. under nitrogen blanketing, the mixture is stirred, and the time t until the gelling point, i.e., until a sharp rise in viscosity, above a threshold value of 1 Pas for example, is measured. The time t thus determined is correlated with the similarly determined time period t_{reference} for the redox initiator system N,N-di(2-hydroxyethyl)aniline/dibenzoyl peroxide.

Preference is given in accordance with the invention to those amines, particularly those amines of the formula (III), for which

t:t_{reference}=0.5-1.5, more preferably 0.66-1.33, very preferably 0.8-1.2, and in particular 0.9-1.1.

Without wishing to be tied to any one theory it may be supposed that, as a result of the—in comparison to dimethylaniline or dimethyl-p-toluidine—more sterically bulky radicals and stronger +I-active radicals R¹ and R² in the systems of the invention, on the one hand, free-radical centers form less readily on the nitrogen atom and, on the other hand, these centers are better shielded and hence more stable, so that the reactivity of the amine-peroxide initiator system of the invention is moderated in relation to the corresponding system with dimethylaniline or dimethyl-p-toluidine.

c) At least one compound having at least one ethylenically α,β-unsaturated carbonyl compound.

Such compounds may preferably be unsaturated polyesters or (meth)acrylate compounds.

With particular preference they are (meth)acrylate compounds, very preferably acrylate compounds, .i.e., derivatives of acrylic acid.

The unsaturated polyesters and (meth)acrylate compounds comprise more than 2, preferably 2 to 20, more preferably 2 to 10, and very preferably 2 to 6 free-radically polymerizable, α,β-ethylenically unsaturated carbonyl groups.

Compounds of this kind having at least two free-radically polymerizable groups may be present in a mixture with reactive diluents—that is, compounds having a free-radically polymerizable group.

Particular preference is given to those compounds having an ethylenically unsaturated double bond content of 0.1-0.7 mol /100 g, very preferably 0.2-0.6 mol/100 g.

Unless indicated otherwise the number-average molecular weight Mₙ of the compounds is preferably below 15 000, more preferably 300-12 000, very preferably 400 to 5000, and in particular 500-3000 g/mol (determined by gel permeation chromatography using polystyrene as the standard and tetrahydrofuran as the eluent).

Unsaturated polyesters are polyesters synthesized from diols and dicarboxylic acids having in each case at least two hydroxyl and carboxyl groups, respectively, and also, if appropriate, from polyols and/or polycarboxylic acids having in each case at least three hydroxyl or carboxyl groups, respectively, with the proviso that said dicarboxylic acid comprises in incorporated form at least partly at least one α, β-unsaturated dicarboxylic acid component. α,β-Unsaturated dicarboxylic acid components of this kind are preferably maleic acid, fumaric acid or maleic anhydride, more preferably maleic anhydride.

Dicarboxylic acids for synthesizing such polyesters are oxalic acid, maleic acid, fumaric acid, succinic acid, glutaric acid, adipic acid, sebacic acid, dodecanedioic acid, o-phthalic acid, isophthalic acid, terephthalic acid, azelaic acid, 1,4-cyclohexane-dicarboxylic acid or tetrahydrophthalic acid, suberic acid, phthalic anhydride, tetrahydrophthalic anhydride, hexahydrophthalic anhydride, tetrachlorophthalic anhydride, endomethylenetetrahydrophthalic anhydride, glutaric anhydride, dimeric fafty acids, their isomers and hydrogenation products, and esterifiable derivatives, such as anhydrides or dialkyl esters, C₁-C₄ alkyl esters for example, preferably methyl, ethyl or n-butyl esters, of said acids. Preferred dicarboxylic acids are of the general formula HOOC-(CH₂)γ-COOH where y is a number from 1 to 20, preferably an even number from 2 to 20, and more preferably are succinic acid, adipic acid, sebacic acid, and dodecanedicarboxylic acid.

Polycarboxylic acids for synthesizing such polyesters are for example trimellitic acid, hemimellitic acid, trimesic acid or the anhydrides thereof.

Diols for synthesizing such polyesters are 1,2-propanediol, ethylene glycol, 2,2-dimethyl-1,2-ethanediol, 1,3-propanediol, 1,2-butanediol, 1,3- or 1,4-butanediol, 3-methylpentane-1,5-diol, 2-ethylhexane-1,3-diol, 2,4-diethyloctane-1,3-diol, 1,6-hexanediol, diethylene glycol, triethylene glycol, tetraethylene glycol, pentaethylene glycol, neopentyl glycol, neopentyl glycol hydroxypivalate, 2-ethyl-1,3-propanediol, 2-methyl-1,3-propanediol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexanedimethanol, 1,2-, 1,3-or 1,4-cyclohexanediol. Preferred alcohols are of the general formula HO-(CH₂)X-OH where x is a number from 1 to 20, preferably an even number from 2 to 20. Preference is given to ethylene glycol, butane-1,4-diol, hexane-1,6-diol, octane-1,8-diol, and dodecane-1,12-diol. Preference is additionally given to neopentyl glycol.

Polyols for synthesizing such polyesters are trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, and isomalt.

Also suitable are lactone-based polyester diols, which are homopolymers or copolymers of lactones, preferably hydroxyl-terminated adducts of lactones with suitable difunctional starting molecules. Suitable lactones are preferably those derived from compounds of the general formula HO-(CH₂)_{z}-COOH where z is a number from 1 to 20 and where one hydrogen atom of a methylene unit may also have been substituted by a C₁ to C₄ alkyl radical. Examples are δ-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are for example the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. Instead of the polymers of lactones it is also possible to use the corresponding, chemically equivalent polycondensates of the hydroxy carboxylic acids corresponding to the lactones.

As (meth)acrylate compounds mention may be made of (meth)acrylic esters and especially acrylic esters of polyfunctional alcohols, particularly those which other than the hydroxyl groups comprise no further functional groups or, if they comprise any at all, comprise ether groups. Examples of such alcohols are, e.g., difunctional alcohols, such as ethylene glycol, propylene glycol, and their counterparts with higher degrees of condensation, for example such as diethylene glycol, triethylene glycol, dipropylene glycol, tripropylene glycol etc., 1,2-, 1,3- or 1,4-butanediol, 1,5-pentanediol, 1,6-hexanediol, 3-methyl-1,5-pentanediol, neopentyl glycol, alkoxylated phenolic compounds, such as ethoxylated and/or propoxylated bisphenols, 1,2-, 1,3- or 1,4-cyclohexanedimethanol, alcohols with a functionality of three or higher, such as glycerol, trimethylolpropane, butanetriol, trimethylolethane, pentaerythritol, ditrimethylolpropane, dipentaerythritol, sorbitol, mannitol, and the corresponding alkoxylated, especially ethoxylated and/or propoxylated, alcohols, and, furthermore, polyTHF having a molar weight between 162 and 2000, poly-1,3-propanediol having a molar weight between 134 and 2000 or polyethylene glycol having a molar weight between 238 and 2000.

The alkoxylation products are obtainable in a known way by reacting the above alcohols with alkylene oxides, especially ethylene oxide or propylene oxide. The degree of alkoxylation per hydroxyl group is preferably 0 to 10; in other words, 1 mol of hydroxyl group may be alkoxylated with up to 10 mol of alkylene oxides.

As (meth)acrylate compounds mention may further be made of polyester (meth)acrylates, which are the (meth)acrylic esters of polyesterols, and also urethane, epoxy, polyether, silicone, carbonate or melamine (meth)acrylates.

Particularly suitable coating compositions are those of the invention in which at least one compound c) is a urethane (meth)acrylate or polyester (meth)acrylate, with very particular preference at least one urethane (meth)acrylate.

Urethane (meth)acrylates are obtainable for example by reacting polyisocyanates with hydroxyalkyl (meth)acrylates and, if appropriate, chain extenders such as diols, polyols, diamines, polyamines or dithiols or polythiols.

The urethane (meth)acrylates preferably have a number-average molar weight Mn of 500 to 20 000, in particular from 750 to 10 000, more preferably 750 to 3000 g/mol (determined by gel permeation chromatography using polystyrene as the standard).

The urethane (meth)acrylates preferably have a (meth)acrylic group content of 1 to 5, more preferably of 2 to 4 mol per 1000 g of urethane (meth)acrylate.

Epoxy (meth)acrylates are obtainable by reacting epoxides with (meth)acrylic acid. Examples of suitable epoxides include epoxidized olefins or glycidyl ethers, e.g., bisphenol A diglycidyl ether, or aliphatic glycidyl ethers, such as butanediol diglycidyl ether.

Melamine (meth)acrylates are obtainable by reacting melamine with (meth)acrylic acid or esters thereof.

The epoxy (meth)acrylates and melamine (meth)acrylates preferably have a number-average molar weight Mₙ of 500 to 20 000, more preferably of 750 to 10 000 g/mol, and very preferably of 750 to 3000 g/mol. The (meth)acrylic group content is preferably 1 to 5, more preferably 2 to 4, per 1000 g of epoxy (meth)acrylate or melamine (meth)acrylate (determined by gel permeation chromatography using polystyrene as the standard and tetrahydrofuran as the eluent).

Also suitable are carbonate (meth)acrylates which comprise on average preferably 1 to 5, especially 2 to 4, more preferably 2 to 3 (meth)acrylic groups and very preferably 2 (meth)acrylic groups.

The number-average molecular weight Mₙ of carbonate (meth)acrylates is preferably less than 3000 g/mol, more preferably less than 1500 g/mol, very preferably less than 800 g/mol (as determined by gel permeation chromatography using polystyrene as the standard with tetrahydrofuran solvent).

The carbonate (meth)acrylates are obtainable in a simple way by transesterifying carbonic esters with polyhydric, preferably dihydric, alcohols (diols, e.g., hexanediol) and subsequently esterifying the free OH groups with (meth)acrylic acid or else transesterifying with (meth)acrylic esters, as is described for example in EP-A 92 269. They are also obtainable by reacting phosgene, urea derivatives with polyhydric, e.g., dihydric, alcohols.

Suitable reactive diluents include radiation-curable, free-radically or cationically polymerizable compounds having only one ethylenically unsaturated copolymerizable group.

Examples that may be mentioned include C₁-C₂₀ alkyl (meth)acrylates, vinylaromatics having up to 20 carbon atoms, vinyl esters of carboxylic acids comprising up to 20 carbon atoms, ethylenically unsaturated nitriles, vinyl ethers of alcohols comprising 1 to 10 carbon atoms, α,β-unsaturated carboxylic acids and their anhydrides, and aliphatic hydrocarbons having 2 to 8 carbon atoms and 1 or 2 double bonds.

Preferred (meth)acrylic acid alkyl esters are those with a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters as well are suitable.

Vinyl esters of carboxylic acids having 1 to 20 carbon atoms are for example vinyl laurate, vinyl stearate, vinyl propionate, and vinyl acetate.

α, β-Unsaturated carboxylic acids and their anhydrides may be, for example, acrylic acid, methacrylic acid, fumaric acid, crotonic acid, itaconic acid, maleic acid or maleic anhydride, preferably acrylic acid.

Examples of suitable vinylaromatic compounds include vinyltoluene, α-butylstyrene, 4-n-butylstyrene, 4-n-decylstyrene, and, preferably, styrene.

Examples of nitriles are acrylonitrile and methacrylonitrile.

Suitable vinyl ethers are, for example, vinyl methyl ether, vinyl isobutyl ether, vinyl hexyl ether, and vinyl octyl ether.

As nonaromatic hydrocarbons having 2 to 8 carbon atoms and one or two olefinic double bonds mention may be made of butadiene, isoprene, and also ethylene, propylene, and isobutylene.

Additional candidates for use are N-vinylformamide, N-vinylpyrrolidone, and N-vinyl-caprolactam.

d) At least one photoinitiator

As photoinitiators it is possible to use those photoinitiators that are known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds.), SITA Technology Ltd, London.

In accordance with the invention this comprehends those photoinitiators which release free radicals on exposure to light and are able to initiate a free-radical reaction, such as free-radical polymerization for example.

Suitable examples include phosphine oxides, benzophenones, α-hydroxy-alkyl aryl ketones, thioxanthones, anthraquinones, acetophenones, benzoins and benzoin ethers, ketals, imidazoles or phenylglyoxylic acids, and mixtures thereof.

Phosphine oxides are, for example, mono- or bisacylphosphine oxides, such as bis(2,4,6-trimethylbenzoyl)phenylphosphine oxide, as described for example in EP-A 7 508, EP-A 57 474, DE-A 196 18 720, EP-A 495 751 or EP-A 615 980, examples being 2,4,6-trimethylbenzoyldiphenylphosphine oxide, ethyl 2,4,6-trimethylbenzoylphenyl-phosphinate or bis(2,6-dimethoxybenzoyl)-2,4,4-trimethylpentylphosphine oxide; benzophenones are, for example, benzophenone, 4-aminobenzophenone, 4,4′-bis(di-methylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone;

α-hydroxy-alkyl aryl ketones are, for example, 1-benzoylcyclohexan-1-ol (1-hydroxy-cyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or a polymer comprising 2-hydroxy-2-methyl-1-(4-isopropen-2-ylphenyl)propan-1-one in copolymerized form (Esacure® KIP 150); xanthones and thioxanthones are, for example, 10-thioxanthenone, thioxanthen-9-one, xanthen-9-one, 2,4-dimethylthioxanthone, 2,4-diethylthioxanthone, 2,4-diisopropylthio-xanthone, 2,4-dichlorothioxanthone or chloroxanthenone;

anthraquinones are, for example, p-methylanthraquinone, tert-butylanthraquinone, anthraquinonecarboxylic esters, benz[de]anthracen-7-one, benz[a]anthracene-7,12-dione, 2-methylanthraquinone, 2-ethylanthraquinone, 2-tert-butylanthraquinone, 1-chloroanthraquinone or 2-amylanthraq uinone;

acetophenones are, for example, acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]- 2-morpholinopropan-1-one, 2,2-dimethoxy-1,2-diphenylethan-2-one or 2-benzyl-2- dimethylamino-1-(4-morpholinophenyl)butan-1-one;

benzoins and benzoin ethers are, for example, 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; or

ketals are, for example, acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Photoinitiators which can be used additionally are, for example, benzaldehyde, methyl ethyl ketone, 1-naphthaldehyde, triphenylphosphine, tri-o-tolylphosphine or 2,3-butane-dione. Typical mixtures comprise, for example, 2-hydroxy-2-methyl-1-phenylpropan-2-one and 1-hydroxycyclohexyl phenyl ketone, bis(2,6-dimethoxybenzoyl)-2,4,4-trimethyl-pentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethyl-pentylphosphine oxide and 1-hydroxycyclohexyl phenyl ketone, 2,4,6-trimethylbenzoyl-diphenylphosphine oxide and 2-hydroxy-2-methyl-1-phenylpropan-1-one, 2,4,6-trimethylbenzophenone and 4-methylbenzophenone, or 2,4,6-trimethylbenzophenone and 4-methylbenzophenone and 2,4,6-trimethylbenzoyldiphenylphosphine oxide.

In one particular embodiment of the present invention amino-containing photoinitiators are used as compounds c), examples being 4-aminobenzophenone, 4,4′-bis(dimethyl-amino)benzophenone, 2-benzyl-2-dimethylamino-1-(4-morpholinophenyl)butan-1-one or 4-morpholinodeoxybenzoin.

e) If appropriate, at least one pigment.

Pigments are, according to CD Rompp Chemie Lexikon—Version 1.0, Stuttgart/New York: Georg Thieme Verlag 1995, with reference to DIN 55943, particulate “organic or inorganic, chromatic or achromatic colorants which are virtually insoluble in the application medium”.

Virtually insoluble here means a solubility at 25° C. of less than 1 g/1000 g of application medium, preferably below 0.5, more preferably below 0.25, very preferably below 0.1 and in particular below 0.05 g/1000 g of application medium.

Examples of pigments comprise any desired systems of absorption pigments and/or effect pigments, preferably absorption pigments. The number and selection of the pigment components are not subject to any restrictions whatsoever. They may be adapted to the particular requirements, such as the desired color impression, for example, in an arbitrary way. By way of example it is possible for all of the pigment components of a standardized paint mixer system to be taken as the basis.

By effect pigments are meant all pigments which exhibit a platelet-shaped construction and impart specific decorative color effects to a surface coating. The effect pigments are, for example, all of the effect-imparting pigments which can be employed commonly in vehicle finishing and industrial coating. Examples of effect pigments of this kind are pure metal pigments, such as, for example, aluminum, iron or copper pigments, interference pigments, such as, for example, titanium dioxide-coated mica, iron oxide-coated mica, mixed oxide-coated mica (e.g., with titanium dioxide and Fe₂O₃ or titanium dioxide and Cr₂O₃), metal oxide-coated aluminum, or liquid-crystal pigments.

The color-imparting absorption pigments are, for example, customary organic or inorganic absorption pigments which can be used in the paint industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants and differ from the pigments in their solubility in the application medium, i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes can be employed as basic or cationic dyes, mordant dyes, direct dyes, disperse dyes, developing dyes, vat dyes, metal complex dyes, reactive dyes, acid dyes, sulfur dyes, coupling dyes or substantive dyes.

In contrast thereto, coloristically inert fillers are all substances/compounds which on the one hand are coloristically inactive—that is, they exhibit little intrinsic absorption and have a refractive index similar to that of the coating medium—and on the other hand are capable of influencing the orientation (parallel alignment) of the effect pigments in the surface coating, i.e., in the applied paint film, and also properties of the coating or of the coating compositions, such as hardness or rheology. Inert substances/ compounds which can be used are given by way of example below, but without restricting the concept of coloristically inert, topology-influencing fillers to these examples. Suitable inert fillers meeting the definition may be, for example, transparent or semitransparent fillers or pigments, such as, for example, silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, from glass, ceramic or polymers and having sizes of for example 0.1-50 μm. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Particularly preferred coating compositions of the invention comprise at least one pigment.

By the coating medium is meant the medium surrounding the pigment, examples being transparent varnishes or clearcoat materials, binders, powders, for powder coatings for example, polymeric films, or sheets and foils.

The coating compositions of the invention may further, optionally, be capable of chemical curing. po The term “dual cure” or “multicure” refers in the context of this specification to a cure process which takes place via two or, respectively, more than two mechanisms selected for example from radiation, moisture, chemical, oxidative and/or thermal curing, preferably selected from radiation, moisture, chemical and/or thermal curing, and more preferably selected from radiation, chemical and/or thermal curing.

Radiation curing for the purposes of this specification is defined as the polymerization of polymerizable compounds consequent upon electromagnetic and/or corpuscular radiation, preferably UV light in the wavelength range of λ=200 to 700 nm and/or electron beams in the range from 150 to 300 keV, and more preferably with a radiation dose of at least 80, preferably 80 to 3000, mJ/cm².

Thermal curing for the purposes of this specification here denotes free-radical polymerization consequent upon decomposition of peroxy compounds a) at a temperature from 20° C. to 120° C.

Chemical curing for the purposes of this specification is defined as the polymerization of polymerizable compounds consequent upon a reaction of isocyanate groups (—NCO), capped if appropriate, with isocyanate-reactive groups, examples being hydroxyl (—OH), primary amino (—NH₂), secondary amino (—NH—) or thiol groups (—SH), preferably hydroxyl, primary amino or secondary amino groups, more preferably hydroxyl or primary amino groups, and very preferably hydroxyl groups.

To this end the coating compositions of the invention may further comprise at least one isocyanate-functional component f) and at least one component g) comprising at least one isocyanate-reactive group.

Isocyanate-functional components f) are for example aliphatic, aromatic, and cycloaliphatic di- and polyisocyanates having an NCO functionality of at least 1.8, preferably 1.8 to 5 and more preferably 2 to 4, and also their isocyanurates, biurets, uretdiones, urethanes, allophanates, oxadiazinetriones, and iminooxadiazinediones.

The diisocyanates are preferably isocyanates having 4 to 20 carbon atoms. Examples of customary diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)- methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also aromatic diisocyanates such as 2,4- or 2,6-tolylene diisocyanate and isomer mixtures thereof, m- or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Suitable polyisocyanates include polyisocyanates containing isocyanurate groups, uretdione diisocyanates, polyisocyanates containing biuret groups, polyisocyanates containing urethane or allophanate groups, polyisocyanates comprising oxadiazine-trione groups or iminooxadiazinedione groups, uretonimine-modified polyisocyanates of linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

The di- and polyisocyanates which can be employed preferably have an isocyanate group content (calculated as NCO, molecular weight=42) of 10% to 60% by weight, based on the diisocyanate and polyisocyanate (mixture), preferably 15% to 60% by weight, and more preferably 20% to 55% by weight.

Preference is given to aliphatic and/or cycloaliphatic di- and polyisocyanates, examples being the abovementioned aliphatic and/or cycloaliphatic diisocyanates, or mixtures thereof.

Particular preference is given to hexamethylene diisocyanate, 1,3-bis(isocyanato-methyl)cyclohexane, isophorone diisocyanate and di(isocyanatocyclohexyl)methane, very particular preference to isophorone diisocyanate and hexamethylene diisocyanate, and especial preference to hexamethylene diisocyanate.

Preference extends to
1) Isocyanurate-group-containing polyisocyanates of aromatic, aliphatic and/or cycloaliphatic diisocyanates. Particular preference here goes to the corresponding aliphatic and/or cycloaliphatic isocyanato-isocyanurates and, in particular, to those based on hexamethylene diisocyanate and isophorone diisocyanate. The present isocyanurates are, in particular, tris-isocyanatoalkyl and/or tris-isocyanatocycloalkyl isocyanurates, which represent cyclic trimers of the diisocyanates, or are mixtures with their higher homologs containing more than one isocyanurate ring. The isocyanato-isocyanurates generally have an NCO content of from 10% to 30% by weight, in particular from 15% to 25% by weight, and an average NCO functionality of from 2.6 to 4.5.
2) Uretdione diisocyanates containing aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.

The uretdione diisocyanates can be used in the formulations of the invention as a sole component or in a mixture with other polyisocyanates, especially those mentioned under 1).
3) Polyisocyanates containing biuret groups and aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of from 18% to 25% by weight and an average NCO functionality of from 2.8 to 4.5.
4) Polyisocyanates containing urethane and/or allophanate groups and aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with monohydric or polyhydric alcohols such as for example methanol, ethanol, isopropanol, n-propanol, n-butanol, isobutanol, sec-butanol, tert-butanol, n-pentanol, n-hexanol, n-heptanol, n-octanol, n-decanol, n-dodecanol (lauryl alcohol), 2-ethyihexanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol or polyhydric alcohols as listed above for the polyesterols, or mixtures thereof. These polyisocyanates containing urethane and/or allophanate groups generally have an NCO content of from 12% to 20% by weight and an average NCO functionality of from 2.5 to 4.5.
5) Polyisocyanates comprising oxadiazinetrione groups, derived preferably from hexamethylene diisocyanate or isophorone diisocyanate. Polyisocyanates of this kind comprising oxadiazinetrione groups can be prepared from diisocyanate and carbon dioxide.
6) Polyisocyanates comprising iminooxadiazinedione groups, preferably derived from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.

The polyisocyanates 1) to 7) can be used in a mixture, including if appropriate in a mixture with diisocyanates.

The isocyanate groups may also be in capped form. Examples of suitable capping agents for NCO groups include oximes, phenols, imidazoles, pyrazoles, pyrazolinones, diketopiperazines, caprolactam, malonic esters or compounds as specified in the publications by Z. W. Wicks, Prog. Org. Coat. 3 (1975) 73-99 and Prog. Org. Coat 9 (1981), 3-28, and also in Houben-Weyl, Methoden der Organischen Chemie, Vol. XIV/2, 61 ff. Georg Thieme Verlag, Stuttgart 1963, or tert-butylbenzylamine, as is described for example in DE-A1 102 26 925.

By blocking or capping agents are meant compounds which transform isocyanate groups into blocked (capped or protected) isocyanate groups, which then, below a temperature known as the deblocking temperature, do not display the usual reactions of a free isocyanate group. Compounds of this kind with blocked isocyanate groups are commonly employed in dual-cure coating materials which are cured to completion via isocyanate group curing.

Component g) are compounds comprising at least one, preferably at least two, isocyanate-reactive group(s).

They are, for example, diols and/or polyols of relatively high molecular mass, with a molecular weight of approximately 500 to 5000, preferably approximately 100 to 3000, g/mol.

The average functionality is in general with particular preference from 2 to 10.

The diols of relatively high molecular mass are, in particular, polyester polyols, which are known, for example, from Ullmanns Encyklopadie der technischen Chemie, 4th Edition, Volume 19, pp. 62 to 65.

Preference is given to using unsaturated or, preferably, saturated polyester polyols which are obtainable by reacting the dicarboxylic acids mentioned above under c), preferably the saturated dicarboxylic acids mentioned there, with the abovementioned diols, with the addition if appropriate of the abovementioned polycarboxylic acids and/or polyols.

Also suitable, furthermore, are polycarbonate diols, such as may be obtained, for example, by reacting phosgene with an excess of the low molecular mass alcohols specified as synthesis components for the polyester polyols.

Also suitable are lactone-based polyester diols, as set out above under c).

Polyether diols or polyols are suitable in addition. They are obtainable in particular by polymerizing ethylene oxide, propylene oxide, butylene oxide, tetrahydrofuran, styrene oxide or epichlorohydrin with itself, in the presence of BF₃, for example, or by subjecting these compounds, if appropriate as a mixture or in succession, to addition reaction with starting components containing reactive hydrogen atoms, such as alcohols or amines, examples being water, ethylene glycol, propane-1,2-diol, propane-1,3-diol, 2,2-bis(4-hydroxydiphenyl)propane, and aniline, or with the polyols specified above as synthesis components for polyesters, examples being trimethylolpropane or pentaerythritol.

Particular preference is given to polyethylene oxide or polytetrahydrofuran having a molecular weight of 2000 to 5000 g/mol, and especially 3500 to 4500 g/mol.

Preference is given, furthermore, to polyacrylate polyols. These are generally copolymers of essentially (meth)acrylic esters, examples being the C₁-C₂₀ alkyl (meth)acrylates set out above in connection with the reactive diluents, with hydroxyalkyl (meth)acrylates, examples being the mono(meth)acrylic esters of 1,2-propanediol, ethylene glycol, 1,3-propanediol, 1,4-butanediol or 1,6-hexanediol.

They preferably have a molecular weight Mₙ (number average) as determinable by gel permeation chromatography of 500 to 50 000, in particular 1000 to 10 000, g/mol and a hydroxyl number of 16.5 to 264, preferably 33 to 165, mg KOH/g resin solids.

The hydroxyl-containing monomers are used in the copolymerization in amounts such as to result in the abovementioned hydroxyl numbers for the polymers, which correspond generally, moreover, to a polymer hydroxyl group content of 0.5% to 8%, preferably 1% to 5% by weight. In general the hydroxy-functional comonomers are used in amounts of 3% to 75%, preferably 6% to 47% by weight, based on the total weight of the monomers employed. In addition it must of course be ensured that, within the bounds of the figures given, the amount of hydroxy-functional monomers is chosen so as to form copolymers which contain on average per molecule at least two hydroxyl groups.

The non-hydroxy-functional monomers include, for example, the reactive diluents set out above under c), preferably esters of acrylic acid and/or of methacrylic acid with 1 to 18, preferably 1 to 8, carbon atoms in the alcohol residue, such as, for example, methyl acrylate, ethyl acrylate, isopropyl acrylate, n-propyl acrylate, n-butyl acrylate, 2-ethyl-hexyl acrylate, and n-stearyl acrylate, the methacrylates corresponding to these acrylates, styrene, alkyl-substituted styrenes, acrylonitrile, methacrylonitrile, vinyl acetate or vinyl stearate, or any desired mixtures of such monomers. Comonomers containing epoxide groups as well, such as glycidyl acrylate or methacrylate, for example, or monomers such as N-methoxymethylacrylamide or -methacrylamide can be used in small amounts.

The preparation of the polymers can be carried out by polymerization in accordance with customary methods. The polymers are preferably prepared in organic solution.

Continuous or discontinuous polymerization methods are possible. The discontinuous methods include the batch method and the feed method, the latter being preferred. With the feed method the solvent, alone or together with a portion of the monomer mixture, is introduced as an initial charge and heated to the polymerization temperature, the polymerization is initiated free-radically in the case of an initial monomer charge, and the remainder of the monomer mixture is metered in, together with an initiator mixture, over the course of 1 to 10 hours, preferably 3 to 6 hours. If appropriate, reactivation is carried out subsequently in order to carry out the polymerization to a conversion of at least 99%.

Examples of suitable solvents include aromatics, such as benzene, toluene, xylene, and chlorobenzene, esters such as ethyl acetate, butyl acetate, methyl glycol acetate, ethyl glycol acetate, and methoxypropyl acetate, ethers such as butylglycol, tetrahydrofuran, dioxane, and ethylglycol ether, ketones such as acetone, and methyl ethyl ketone, and halogenated solvents such as methylene chloride or trichloromonofluoroethane.

In addition it is also possible to use low molecular mass diols and polyols having a molecular weight of about 50 to 500, preferably of 60 to 200 g/mol.

Use is made as well, in particular, of the synthesis components of the short-chain diols or polyols specified for the preparation of polyester polyols, preference being given to the diols and polyols having 2 to 12 carbon atoms.

In one preferred embodiment of the invention there is at least one compound f) and at least one compound g) present.

The present invention further provides a process for preparing the coating composition of the invention, in which the constituent components a) and b) are not mixed with one another until shortly before the coating composition is applied to the substrate, preferably not more than 60 minutes beforehand, more preferably not more than 45 minutes, very preferably not more than 30 minutes, and in particular not more than 15 minutes. The constituent components a) and b) are preferably mixed with one another each in suspension or solution in component c).

Where the optional constituent components f) and g) are present in addition, it may be sensible to admix one of these solutions or suspensions in each case to the constituent components a) and b) in c), so producing premixes comprising a) and g) in c) and also b) and f) in c) or, preferably, a) and f) in c) and also b) and g) in c).

The coating compositions of the invention generally have the following constitution:
a) 0.1%-5%, preferably 0.2%-4%, more preferably 0.5%-3%, and very preferably 1%-3% by weight,
b) 0.01%-2%, preferably 0.1%-1.5%, more preferably 0.2%-1%, and very preferably 0.5%-1% by weight
c) 20%-99%, preferably 25%-98%, more preferably 30% to 95%, and very preferably 40% to 90% by weight,
d) 0.1% to 5%, preferably 0.2% to 4%, more preferably 0.3% to 3%, and very preferably 0.5% to 2% by weight,
e) 0-50%, preferably 0 to 40%, more preferably 5% to 30%, and very preferably 10% to 25% by weight, and
f) 0-50%, preferably 0 to 40%, more preferably 5% to 30%, and very preferably 10% to 25% by weight with the proviso that the sum makes 100% by weight.

The weight ratio of the two components of the redox initiator system, a) and b), can vary from 10:1 to 1:5, preferably from 5:1 to 1:1, more preferably 3:1 to 1:1.

Likewise disclosed is a method of coating substrates, in which at least one coating composition of the invention is employed.

The substrates are coated in accordance with customary methods known to the skilled worker, which involve applying at least one coating composition of the invention or coating formulation comprising it to the substrate to be coated, in the desired thickness, and removing the volatile constituents of the coating composition, with heating if appropriate. This operation can if desired be repeated one or more times. Application to the substrate may take place in a known way, by means, for example, of spraying, troweling, knife coating, brushing, rolling, roller coating or pouring. The coating thickness is generally situated within a range from about 3 to 1000 g/m² and preferably 10 to 200 g/m².

Further disclosed is a method of coating substrates that comprises admixing the coating compositions of the invention or coating formulations comprising them with, if appropriate, further, typical coatings additives and thermally curable resins, applying the additized compositions or formulations to the substrate and, if appropriate, drying the applied coating, then subjecting it to curing with electron beams or UV light under an oxygenous atmosphere or, preferably, under inert gas, if appropriate at temperatures up to the level of the drying temperature, and then thermally treating the precured coating at temperatures up to 120° C., preferably between 40 and 100° C., and more preferably between 40 and 80° C.

By drying in this case is meant an operation in the course of which not more than 10% of all curable compounds in the coating composition are polymerized, preferably not more than 8%, more preferably not more than 5%, and very preferably not more than 2.5%.

The method of coating substrates may also be carried out in such a way that following the application of the coating composition of the invention or coating formulations first thermal treatment takes place at temperatures up to 160° C., preferably between 60 and 160° C., and then curing takes place with electron beams or UV light under oxygen or, preferably, under inert gas.

The curing of films formed on the substrate may if desired take place exclusively by thermal means. Generally speaking and preferably, however, the coatings are cured both by exposure to high-energy radiation and thermally.

If appropriate, if two or more films of the coating composition are applied one above another, a thermal and/or radiation cure can take place after each coating operation.

Suitable radiation sources for the radiation cure are, for example, low-pressure, medium-pressure mercury lamps with high-pressure lamps, and also fluorescent tubes, pulsed emitters, metal halide lamps, electronic flash equipment, which allows radiation curing without a photoinitiator, or excimer emitters. The radiation cure is effected by exposure to high-energy radiation, in other words UV radiation or daylight, preferably light in the wavelength range from λ=200 to 700 nm, more preferably from λ=200 to 500 nm, and very preferably λ=250 to 400 nm, or by bombardment with high-energy electrons (electron beams; 150 to 300 keV). Examples of radiation sources used include high-pressure mercury vapor lamps, lasers, pulsed lamps (flash light), halogen lamps or excimer emitters. The radiation dose customarily sufficient for crosslinking in the case of UV curing is situated in the range from 80 to 3000 mJ/cm².

It will be appreciated that two or more radiation sources can also be employed for the cure, e.g., two to four.

These sources may also emit each in different wavelength ranges.

The cure may also take place, in addition to or instead of the thermal cure, by means of NIR radiation, NIR radiation here denoting electromagnetic radiation in the wavelength range from 760 nm to 2.5 μm, preferably from 900 to 1500 nm.

Irradiation may also be carried out preferably in the absence of oxygen, e.g., under an inert gas atmosphere. Suitable inert gases include, preferably, nitrogen, noble gases, carbon dioxide or combustion gases. Irradiation may also take place with the coating composition covered by transparent media. Examples of transparent media are polymeric films, glass or liquids, water for example. Particular preference is given to irradiation in the manner described in DE-A1 199 57 900.

In one preferred embodiment irradiation is carried out in the presence of an inert gas which is heavier than air.

The molar weight of an inert gas which is heavier than air is greater than 28.8 g/mol (corresponding to the molar weight of a gas mixture of 20% oxygen, O₂, and 80% nitrogen, N₂), preferably greater than 30 g/mol, more preferably at least 32 g/mol, in particular greater than 35 g/mol. Suitable examples include noble gases such as argon, hydrocarbons, and halogenated hydrocarbons. Particular preference is given to carbon dioxide.

The terms “protective gas” and “inert gas” are used synonymously in this specification and designate those compounds which, under exposure to high-energy radiation, show no substantial reaction with the coating compositions and do not adversely affect the curing thereof in terms of rate and/or quality. Comprehended in particular by these terms is a low oxygen content. “Show no substantial reaction” herein means that, on the exposure to high-energy radiation that is carried out in the operation, the inert gases react to an extent of less than 5 mol % per hour, preferably less than 2 mol % per hour, and more preferably less than 1 mol % per hour, with the coating compositions or with other substances present within the apparatus.

In the course of the radiation cure the average oxygen (O₂) content in the inert gas atmosphere ought to be less than 15%, preferably less than 10%, more preferably less than 8%, very preferably less than 6%, and in particular less than 3% by volume, based in each case on the total amount of gas in the inert gas atmosphere. It may be sensible to set average oxygen contents below 2.5%, preferably below 2.0%, and with particular preference even below 1.5% by volume.

The invention further provides a method of coating substrates which comprises
i) coating a substrate with a coating composition as described above,
ii) removing volatile constituents of the coating composition in order to form a film, under conditions in which the photoinitiator and/or thermal initiator as yet essentially forms no free radicals,
iii) if appropriate, subjecting the film formed in step ii) to high-energy irradiation, in the course of which the film is precured, and subsequently, if appropriate, machining the article coated with the precured film or contacting the surface of the precured film with another substrate, and,
iv) subjecting the film to a final thermal cure.

Steps iv) and iii) here may also be carried out in reverse order, i.e., the film can be cured first thermally and then with high-energy radiation.

The coating compositions of the invention are particularly suitable for coating substrates such as wood, paper, textile, leather, nonwoven, plastics surfaces, glass, ceramic, mineral building materials, such as cement moldings and fiber-cement slabs, or coated or uncoated metals, preferably plastics or metals, which may be in the form, for example, of films, sheets or foils.

With particular preference the coating compositions of the invention are suitable for coating porous substrates, such as wood or mineral building materials, for example, since within the pores often shadow regions are formed which cannot be reached by radiation curing. In shadow regions where photoinitiators cannot be activated by UV radiation, it is then possible to cure the coating compositions of the invention thermally, leading to comprehensive curing of the coating.

With particular preference the coating compositions of the invention are suitable as or in exterior coatings, i.e., in those applications where they are exposed to daylight, preferably on buildings or parts of buildings, interior coatings, traffic markings, and coatings on vehicles and aircraft. In particular the coating compositions of the invention are used as or in automotive clearcoat and/or topcoat material(s).

In the case of use in films, sheets or foils, particular substrates are preferred:

The substrate layer is composed preferably of a thermoplastic polymer, particularly polymethyl methacrylates, polybutyl methacrylates, polyethylene terephthalates, polybutylene terephthalates, polyvinylidene fluorides, polyvinyl chlorides, polyesters, polyolefins, acrylonitrile-ethylene-propylene-diene-styrene copolymers (A-EPDM), polyetherimides, polyether ketones, polyphenylene sulfides, polyphenylene ethers or blends thereof.

Mention may also be made of polyethylene, polypropylene, polystyrene, polybutadiene, polyesters, polyamides, polyethers, polycarbonate, polyvinyl acetal, polyacrylonitrile, polyacetal, polyvinyl alcohol, polyvinyl acetate, phenolic resins, urea resins, melamine resins, alkyd resins, epoxy resins or polyurethanes, block copolymers or graft copolymers thereof, and blends thereof.

With preference mention may be made of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF, and UP plastics (abbreviations in accordance with DIN 7728), and aliphatic polyketones.

Particularly preferred substrates are polyolefins, such as PP (polypropylene), which as desired may be isotactic, syndiotactic or atactic and as desired may be unoriented or may have been oriented by uniaxial or biaxial stretching, SAN (styrene-acrylonitrile copolymers), PC (polycarbonates), PMMA (polymethyl methacrylates), PBT (poly(butylene terephthalate)s), PA (polyamides), ASA (acrylonitrile-styrene-acrylate copolymers), and ABS (acrylonitrile-butadiene-styrene copolymers), and also physical mixtures (blends) thereof. Particular preference is given to PP, SAN, ABS, ASA, and also blends of ABS or ASA with PA or PBT or PC.

Very particular preference is given to ASA, especially in accordance with DE 19 651 350, and to the ASA/PC blend. Preference is likewise given to polymethyl methacrylate (PMMA) or to impact-modified PMMA.

It is an advantage of the present invention that with the coating compositions of the invention, which comprise both thermally activatable and radiation-activatable free-radical initiators, free-radically polymerizable coating compositions can be cured even under an oxygenous atmosphere. In the case of curing of the coating composition by means of thermal initiation only, the surface frequently remains uncured, as a result of oxygen inhibition. With the coating compositions of the invention this can be avoided by additional activation of the photoinitiators by means of irradiation.

ppm and percentage figures used in this specification relate, unless indicated otherwise, to percentages and ppm by weight.

### EXAMPLES

### General Remarks

Benzoyl peroxide (bought from Aldrich), here abbreviated to BPO, was selected as oxidizing agent. Three amines (likewise bought from Aldrich) were selected as reducing agents: N,N-dimethyltoluidine (DMT, comparative), N,N-dimethylaniline (DMA, comparative), and N-phenyldiethanolamine (PDEA, inventive).

The resin used in the examples below was a polyurethane acrylate (PUA) resin, synthesized from the isocyanurate of hexamethylene 1,6-diisocyanate (Basonat® HI 100 from BASF AG, Ludwigshafen (DE)), a short-chain diol as chain extender, and hydroxyethyl acrylate, mixed with 30% by weight of 1,6-hexanediol diacrylate as reactive diluent.

Since it is difficult to dissolve BPO in resins, two intermediate formulations were prepared, one comprising the polyurethane acrylate with the peroxide and the other the amine in the PUA. These two formulations were only mixed with one another after the ingredients for dissolution had fully dissolved, so that during the preparation of the formulations it is not possible for any unwanted reactions to occur.

Two α-hydroxyphenyl ketones (Darocur® 1173 (2-hydroxy-2-methyl-1-phenylpropan-1-one) and Irgacure® 184 (1-hydroxycyclohexyl phenyl ketone) from Ciba Spezialitatenchemie) and two acylphosphine oxides (Irgacure® 819 (bis(2,4,6-trimethylbenzoyl) phenylphosphine oxide) from Ciba Spezialitatenchemie and Lucirin® TPO-L (ethyl 2,4,6-trimethylbenzoylphenylphosphinate) from BASF) were used as photoinitiators in order to cure the resin photochemically.

A typical composition, which was used below, unless indicated otherwise, was as follows:

| | |
|---|---|
| Polyurethane acrylate: | 97% by weight |
| Darocur ® 1173: | 1% by weight |
| BPO: | 1.5% by weight |
| PDEA: | 0.5% by weight |

### Example 1

### Determining the Pot Life of Different Initiator Systems in Polyurethane Acrylate

TABLE 1
Pot life of polyurethane acrylate used, with different redox systems
at different temperatures, compared with the stability of polyurethane
acrylate comprising only BPO.

| | |
|---|---|
| Initiator | Pot life |

| system | 25° C. | 60° C. | 80° C. |
|---|---|---|---|
| 1.5% by | several months | >3 h | <3 h |
| weight BPO | | | |
| 1% by weight | 10 minutes | / | / |
| BPO - 1% by | | | |
| weight DMA | | | |
| 1% by weight | <1 minute | / | / |
| BPO - 1% by | | | |
| weight DMT | | | |
| 1% by weight | 15 minutes | / | / |
| BPO - 0.5% | | | |
| by weight | | | |
| PDEA | | | |

### Example 2

Carried out under an air atmosphere, it was not possible to cure fully a 70 μm film of the polyurethane acrylate used. Consequently it was necessary to cure the surface by UV exposure, in order thereby to prevent the diffusion of oxygen, and to cure the lower film layers thermally.

TABLE 2
Persoz hardness in accordance with different curing variants of
the above polyurethane acrylate comprising 1% by weight
Darocur ® 1173 - 1.5% by weight BPO - 0.5% by weight
PDEA with a UV dose of 240 mJ × cm⁻² under either air or CO₂
atmosphere.

Persoz hardness

| Curing | INERT | Air |
|---|---|---|
| UV curing | 124 s | 78 s |
| 20 min 80° C. | 208 s | remains liquid |
| UV curing + 20 min | 211 s | 158 s |
| 80° C. | | |
| UV curing + 60 min | 200 s | 100 s |
| 25° C. | | |

### Example 3

### Thermal and Radiation Curing of a Pigmented System

The efficiency of the BPO/PDEA redox system in curing thick, pigmented films was likewise investigated for polyurethane acrylates comprising 3% by weight carbon black pigment. The use of an acylphosphine oxide photoinitiator alone only brought about curing of the top layer of a film 7 mm thick. The polymerization at the surface can be carried out almost completely if the film is exposed to a high UV dose (Table 3). The films of such thickness comprising 3% by weight carbon black, however, cannot be cured deep down through the use solely of a photoinitiator, not even by phosphine oxides such as Lucirin TPO-L, which absorb close to the visible range. This is because, with clear films, visible light penetrates more deeply into the films.

Addition of 1.5% by weight BPO and 0.5% by weight PDEA to the polyurethane acrylate formulation comprising carbon black leads to the curing of the whole 7 mm layer within 90 minutes at room temperature. As was expected from the oxygen inhibition, complete curing right through was achieved under an inert atmosphere. Additionally, Darocur® 1173 was chosen as photoinitiator in the formulation in order to obtain effective surface polymerization, which can easily be increased to 100% conversion by raising the UV exposure time.

TABLE 3
Acrylate conversion of the surface, measured by ATR spectroscopy
on a pigmented system comprising a redox initiator system.
Initiator - 3% by weight carbon black - polyurethane acrylate,
UV dose = 300 mJ × cm⁻² per pass

| | | Acrylate conversion on both | | |
|---|---|---|---|---|
| | | surfaces (ATR measurement) | | |
| | | | Bottom face | Thickness |
| Initiator system | Curing | Top face (air) | (glass) | cured |
| 1% by weight | 1 UV pass air | 53% | 0% | 0.3 mm |
| TPO-L | 5 UV passes air | 99% | 0% | 0.9 mm |
| 1% by weight | 1 UV pass air + 50 | 72% | 64% | 7 mm |
| Darocur ® 1173 + 1.5% | minutes 25° C. air | | | |
| by weight BPO + 0.5% | 1 UV pass CO₂ + 90 min | 81% | 99% | 7 mm |
| by weight PDEA | 25° C. CO₂ | | | |

### Example 4

### Yellowing Test

It is feared that the presence of the amine PDEA in the formulation might lead to yellowing. In order to measure the effect of yellowing, UV absorption spectra were recorded for a thermally-cured and UV-cured film comprising an amine, and were compared with a purely radiation-cured sample of the polyurethane acrylate. After about 2000 hours of UV-A irradiation, no yellowing was observed in the case of the thermally cured and UV-cured sample; i.e., there was no significant increase in the absorbance above 400 nm. The presence of the amine therefore has no deleterious effect on the optical properties of the coating, which remains clear and colorless when it is subjected to this accelerated weathering test.

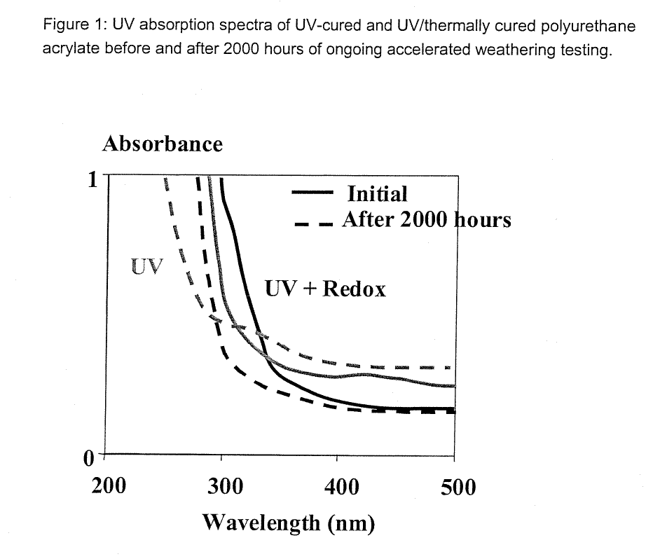

FIG. 1 depicts the UV absorption spectra of UV-cured and UV/thermally cured polyurethane acrylate before and after 2000 hours of ongoing accelerated weathering testing.

Formulation: 1% by weight Irgacure® 819+2% by weight Darocur® 1173+1.5% by weight BPO+0.5% by weight PDEA in polyurethane acrylate. UV dose=350 mJ×cm⁻²+60 minutes heating at 80° C. in a CO₂ atmosphere, 1% by weight Irgacure® 819+2% by weight Darocur® 1173 in polyurethane acrylate, UV dose=350 mJ×cm⁻², 16 μm film thickness.

1. A free-radically curable coating composition comprising
a) at least one compound comprising at least one peroxy group,
b) at least one aromatic amine of the formula I
Ar—NR¹R²,
in which
Ar is an optionally substituted aromatic ring system having 6 to 20 carbon atoms and
R¹ and R² each independently of one another are optionally substituted alkyl radicals, with the proviso that at least one of the two radicals R¹ and R² has at least 2 carbon atoms,
c) at least one compound having at least one ethylenically α, β-unsaturated carbonyl compound,
d) at least one photoinitiator, and
e) if appropriate, at least one pigment.

2. The coating composition according to claim 1, wherein the compounds a) are selected from the group consisting of diacyl peroxides, dialkyl peroxides, and ketone peroxides.

3. The coating composition according to claim 1, wherein peroxy compound a) and amine b) are chosen such that they have 0.5 to 1.5 times the reactivity of a mixture of N,N-di(2-hydroxyethyl)aniline and dibenzoyl peroxide, measured at 25° C. in methyl methacrylate, in the form of 0.5% by weight preparations of the respective amine b) with 1.5% by weight of the respective peroxy compound a), said reactivity being understood as the time between the mixing of amine and peroxy compound and the viscosity increase due to gelling.

4. The coating composition according to claim 1, wherein the amine b) is selected from the group consisting of N,N-diethylaniline, N,N-di-n-butylaniline, N,N-diisopropylaniline, N-methyl-N-(2-hydroxyethyl)aniline, N-methyl-N-(2-hydroxyethyl)-p-tolidine, N,N-diethyl-o-tolidine, N,N-di-n-butyl-o-tolidine, N,N-diethyl-p-tolidine, N,N-di-n-butyl-p-tolidine, N,N-di-(2-hydroxyethyl)aniline, N,N-di-(2-hydroxyethyl)-o-tolidine, N,N-di-(2-hydroxyethyl)-p-tolidine, N,N-di-(2-hydroxypropyl)aniline, N,N-di-(2-hydroxypropyl)-p-tolidine, and N,N-di(2-hydroxypropyl)-o-tolidine.

5. The coating composition according to claim 1, wherein compound c) comprises at least one unsaturated polyester or at least one (meth)acrylate compound.

6. The coating composition according to claim 1, wherein compound c) comprises at least one urethane (meth)acrylate or polyester (meth)acrylate.

7. The coating composition according to claim 1, comprising at least one pigment e).

8. The coating composition according to claim 1, further comprising at least one isocyanate-functional component f) and at least one component g) comprising at least one isocyanate-reactive group.

9. A process for preparing a coating composition according to claim 1, comprising mixing the constituent components a) and b) with one another not more than 60 minutes before applying the coating composition to the substrate.

10. The process according to claim 9, wherein the constituent components a) and b) are mixed with one another each in suspension or solution in component c).

11. (canceled)

12. A method of coating substrates comprising applying a coating composition of claim 1 to the substrates, wherein the substrates are wood, paper, textile, leather, nonwoven, plastics surfaces, glass, ceramic, mineral building materials, or coated or uncoated metals.
